(19) United States
(12) Patent Application Publication
(10) Pub. No.: US 2002/0155241 A1
(43) Pub. Date: Oct. 24, 2002

(54) Surface modifications of medical devices to reduce protein adsorption

(76) Inventors: Barbara J. Tarasevich, Richland, WA (US); Steven C. Goheen, Richland, WA (US)

Correspondence Address: Jason J. Schwartz, Woodard, Emhardt, Naughton, Moriarty and McNett, Bank One Center/Tower, 111 Monument Circle, Suite 3700, Indianapolis, IN, 46204-5137, US

(21) Appl. No.: 09/793,587

(22) Filed: Feb. 26, 2001

(51) Int. Cl. B32B 1/08

(52) U.S. Cl. 428/36.91

(57) ABSTRACT

Feeding tubes are provided having at least an inner surface that is coated with an amount of a source of a hydrophilic functional group effective to reduce protein adsorption and/or subsequent clogging of the feeding tube. In other forms of the invention, feeding tubes having inner surfaces that are provided with the hydrophilic functional group are also described. Methods for reducing protein adsorption to a surface of a feeding tube are also provided.

This invention was made with Government support under contract DE-AC0676RL01830 awarded by the U.S. Department of Energy. The Government has certain rights in the invention.

### BACKGROUND OF THE INVENTION

The present invention relates generally to surface modifications of medical devices. Specifically, the invention relates to modifying feeding tube surfaces to reduce protein adsorption and subsequent clogging of the feeding tube.

Medical devices, including catheters or other implants or objects that are placed in the body, may be exposed to protein-containing biological fluids or other protein-containing solutions that may interact with the medical devices and lead to complications. For example, catheters placed in arteries may bind blood proteins and could lead to formation of thrombi. Additionally, feeding tubes that are used to deliver liquid nutritional products to the stomach have demonstrated clogging over time. Such tubes may be introduced through the nose and throat, or directly through the skin into the stomach. When the tubes become clogged, they must be removed and replaced, which is a costly process that involves a significant amount of discomfort to the patient.

In order to reduce the adverse interactions noted above, materials used to manufacture such medical devices are selected not only on the basis of their physical and mechanical properties, but also on the basis of their compatibility with the protein-containing solutions or biological fluids. It is difficult to optimize these parameters and frequently a compromise must be made. This compromise may lead to manufacture of medical devices from materials that have good physical and mechanical properties, but less than the desired compatibility with protein-containing solutions or biological fluids.

One option in the manufacture of medical devices is to select the material used to construct the medical device based only on their physical and mechanical properties, and then to treat the surface of the device after it has been formed. A wide variety of surface coatings for medical devices are known. Many of these coatings are designed to increase the surface lubricity of the outer surface of the devices, or to otherwise decrease protein adsorption on the outer surface of the devices, but do not address the problem of reducing protein adsorption and subsequent clogging in enteral or other feeding tubes. Therefore, coatings, or modifications of feeding tube surfaces, are needed to reduce protein adsorption and subsequent clogging of feeding tubes. The present invention addresses this need.

### SUMMARY OF THE INVENTION

It has been discovered that a source of a hydrophilic functional group may be coated on a surface of a feeding tube in order to reduce adsorption of proteins to the tube and subsequently to reduce clogging of the tube. Accordingly, in one aspect of the invention, feeding tubes are provided that include an elongated member having an inner surface and an outer surface. The inner surface defines a lumen and at least the inner surface of the tube is coated or otherwise provided with an amount of a source of a hydrophilic functional group effective to reduce adsorption of proteins to the inner surface. In yet another form of the invention, the inner surface of the feeding tube may have, or be provided with, a hydrophilic functional group in an amount effective in reducing protein adsorption to the inner surface.

In other aspects of the invention, methods of reducing protein adsorption to a surface of a feeding tube and subsequent clogging of the tube are provided. In one form, a method includes coating at least an inner surface of a feeding tube with a source of hydrophilic functional group as described herein. In alternative forms of the invention, a method may include providing the inner surface of a feeding tube with a hydrophilic functional group in an amount effective in reducing protein adsorption to the inner surface. This latter method includes modifying preexisting chemical groups that compose the inner surface of the feeding tube as further described herein.

These and other objects and advantages of the present invention will be apparent from the descriptions herein.

### BRIEF DESCRIPTION OF THE FIGURES

FIG. 1 depicts a side perspective view of one embodiment of a feeding tube whose surfaces may be coated or otherwise modified as described herein.

FIG. 2 depicts an end view of the feeding tube of FIG. 1.

FIG. 3 represents a bar graph depicting the amount of Osmolite® adsorbed onto various polyurethane surfaces treated as indicated. OH, self-assembled interface modified with hydroxyl groups; PVA-1, surface treated with polyvinyl alcohol having a molecular weight of 18,000 g/mole; PVA-2, surface treated with polyvinyl alcohol having a molecular weight of 155,000 g/mole; PU, untreated polyurethane surface.

FIG. 4 represents a diagram of the instruments and set-up utilized to measure differences in pressure in variously treated feeding tubes.

FIG. 5A depicts a graph representing the pressure in an untreated feeding tube as a function of time obtained as described in Example 2 for the cycling experiments. The arrows indicate when the expulsion of gastric acid began.

FIG. 5B depicts a graph representing the pressure in a polyvinyl alcohol-treated feeding tube as a function of time obtained as described in Example 2 for the cycling experiments.

FIG. 6 depicts a graph representing the pressure as a function of time in an untreated feeding tube having the original, closed, rounded tip provided from the manufacturer obtained as described in Example 2.

FIG. 7 depicts a bar graph representing the average maximum pressure in various feeding tubes obtained as described in Example 2. The average and standard deviation (shown as error bars) of pressure spikes from treated and untreated tubes are shown. Only the maximum logged pressure from 10 cycles was analyzed as described in Example 2. Untreated, Unaltered Tubing, represents tubing that was not treated with polyvinyl alcohol and having its original, closed, rounded tip. All other tubing samples (treated with polyvinyl alcohol or untreated) had distal ends that were cut off. The Osmolite® alone sample represents tubing through which Osmolite® was passed, but did not undergo cycling between Osmolite® and simulated gastric acid.

### DESCRIPTION OF THE PREFERRED EMBODIMENTS

For the purposes of promoting an understanding of the principles of the invention, reference will now be made to preferred embodiments and specific language will be used to describe the same. It will nevertheless be understood that no limitation of the scope of the invention is thereby intended, such alterations and further modifications of the invention, and such further applications of the principles of the invention as illustrated herein, being contemplated as would normally occur to one skilled in the art to which the invention relates.

The present invention relates to feeding tubes treated to reduce protein adsorption. Specifically, feeding tubes having inner surfaces that have been chemically modified or coated to reduce protein adsorption and subsequent clogging of the feeding tube are provided. As defined herein and as known in the art, clogging includes reduction in flow of material, such as a liquid, through the tube per unit time. Methods for reducing protein adsorption and subsequent clogging of feeding tubes are also provided. The present inventors have discovered that inclusion of a hydrophilic chemical group, preferably an uncharged hydrophilic functional group, such as a hydroxyl or other similar group, on the inner surface of a feeding tube reduces protein adsorption which may be a factor in clogging of feeding tubes. Although not being limited by theory, it is believed that the hydrophilic groups may repel proteins due to the reduction of hydrophobic interactions with the feeding tube surface and due to the formation of a water layer which creates a repulsive hydration force.

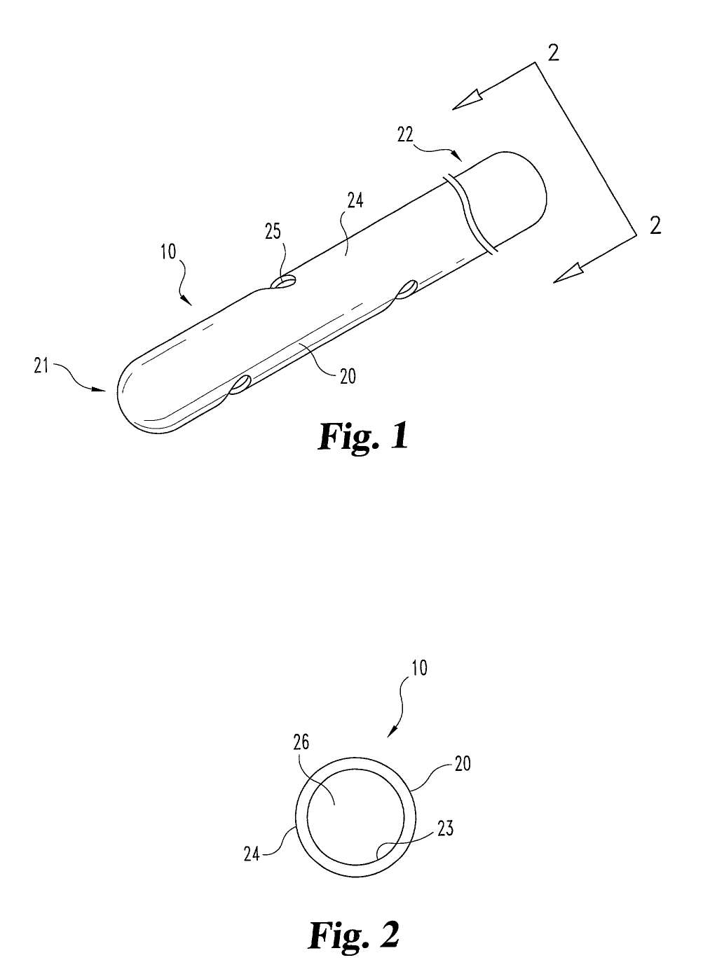

Referring to FIGS. 1 and 2, in one aspect of the invention, a feeding tube 10 is provided that includes an elongated member 20 having a distal end 21, a proximal end 22, an inner surface 23, an outer surface 24 and a plurality of apertures 25 or other openings at distal end 21 is provided. Inner surface 23 defines a lumen 26. In preferred forms of the invention, at least inner surface 23 is coated with an amount of a source of a hydrophilic functional group effective to reduce adsorption of proteins to the inner surface. Such coatings may be effective to reduce clogging of enteral or other feeding tubes, such as when a protein solution or other nutrient solution is delivered through the tube. By “coating”, it is meant that the surface may be contacted with a source of a hydrophilic functional group that will become associated with, either covalently or non-covalently such as by adsorption, to the surface.

The hydrophilic functional groups that may advantageously be utilized in the present invention are preferably uncharged hydrophilic, further preferably polar, groups, including hydroxyl, ester, aldehyde, nitrile and ether functionalities. In yet other forms of the invention, the hydrophilic functional groups may include charged hydrophilic functional groups, such as amino, sulfate, sulfonate, and carboxyl. Other similar functional groups may also be advantageously utilized in the present invention, including phosphate, phosphonate, and amide groups. The terms “hydrophilic” and “hydrophobic” are used herein as defined in the art. Thus, the term “hydrophilic group” denotes a functional or other chemical group which has a strong affinity for water compared to a hydrophobic group whereas the term “hydrophobic group” denotes a functional or other chemical group which has little or no affinity for water compared to a hydrophilic group. As known in the art, hydrophilic groups, for example, may have a contact angle between water and a substrate surface of about 00 to about 900, typically about 00 to about 450. The hydrophilic functional groups may thus be selected so that they will associate or otherwise interact with water, typically by electrostatic interactions, such as hydrogen bonding or other similar interaction.

A wide variety of sources of the advantageous hydrophilic functional groups may be utilized. In preferred forms of the invention, organic polymers may include the functional groups attached thereto. Suitable sources include, for example, polyethylene glycol, polyethylene oxide, polysaccharides such as cellulose, Pluronice surfactants, polyvinyl alcohol such as AIRVOL®, and other polyols and combinations thereof. These sources of hydrophilic functional groups may be purchased commercially or synthesized by methods known to the skilled artisan.

The molecular weight of the sources of hydrophilic functional groups, such as the polymers described herein, may be selected as desired depending on the nature of the source, but is typically sufficient to adsorb the source to the substrate surface. In certain forms of the invention, polymers having a molecular weight of about 5,000 to about 200,000, preferably about 10,000 to about 100,000, and further preferably about 10,000 to about 20,000 g/mole are advantageously utilized. For example, when the organic polymer is polyvinyl alcohol, polyvinyl alcohol having a molecular weight of up to about 155,000 g/mole, and as low as about 18,000 g/mole has advantageously been utilized to coat surfaces to effectively reduce protein adsorption, although smaller and larger molecular weight polymers may also be used.

The feeding tube may be selected from a wide variety of feeding tubes known to the art, including those available from Ross Products, Columbus Ohio. In one form of the invention, the tubes are composed of a hydrophobic material, including a material more hydrophobic than a polyol, such as polyurethane. Other materials that may be utilized to form the feeding tube include polyolefins, such as polystyrene and copolymers thereof, polypropylene and copolymers thereof, polyethylene, polybutadiene and elastic copolymers of butadiene, styrene and acrylonitrile (ABS); polymethyl methacrylate, polymethyl pentene, polycarbonate, polysulfone, fluoropolymers, polyamides, silicones and elastomers, including silicone, hydrocarbon and fluorocarbon elastomers; polyorganosiloxanes and copolymers and combinations thereof. Other suitable hydrophobic or other materials may be used to form the feeding tubes of the present invention. The feeding tubes may be constructed from the polymeric materials described herein and as known in the art by methods known to the skilled artisan.

The surfaces of the feeding tube, such as at least the inner surface, but also including the outer surface in certain forms of the invention, may be modified by coating the surface with the selected source of hydrophilic functional group, or otherwise providing a hydrophilic functional group, by a wide variety of methods well known to the skilled artisan. In one preferred form of the invention, a source of a hydrophilic functional group is adsorbed to the target surface, by, for example, soaking or otherwise contacting the surface with the source of the hydrophilic functional group dispersed in a liquid, including aqueous solutions, and non-aqueous solutions such as ethanol or chloroform.

The source of the hydrophilic functional group may also form a covalent bond to the target surface by surface grafting methods known to the skilled artisan. Such processes are known in the art and are described, for example, in Freij-Larson, C. and Wesslen, B. (1993) J. Applied Polymer Science 50:345-352; and U.S. Pat. No. 5,527,618; and Park, K. O. et al. (1998) Biomaterials 19:851-859.

In other forms of the invention, hydrophilic functional groups may be provided to a surface of the feeding tube by modifying or otherwise converting the pre-existing chemical groups that compose the target surface into desired functional groups by methods known to the skilled artisan. For example, methods for controlling surface composition by converting a surface group into a different, desired group are well known to the art, and include plasma treatment of the surface with water to oxidize, for example, alkylene and/or alkyl groups on the surface to form hydroxyl groups. Other plasma reactions may include plasma treatment with reactive monomers or inert gases, including sulfur dioxide and sulfur trioxide to introduce, for example, sulfonate or sulfate groups. For example, attachment of sulfonate groups to a polyurethane surface may be accomplished in a glow discharge reactor system by purging the system with ammonia, treating at a selected power rating and passing sulfur dioxide gas into the reactor as described, for example, in Giroux, T. A. and Cooper, S. L. (1991) J. of Colloid Interface Sci. 146(1):179-194. Other plasma treatments are described in, for example, Ulubayram, K. and Hasirei, N. (1993) Colloids Surfaces B: Biointerfaces 1:261-269; Sterrett, T. L. et al. (1992) J. Materials Science-Materials in Medicine v. 3 No. 6, 402-407. In yet other forms of the invention, a target surface may be treated, or otherwise contacted or chemically modified, with an oxidizing agent, such as chromic acid, in order to oxidize, for example, alkylene, or alkyl groups to form hydroxyl groups.

The surface of the feeding tube is coated with an effective amount of the source of hydrophilic functional group, or is otherwise provided with an effective amount of a hydrophilic functional group. This amount is typically effective to reduce or otherwise decrease protein adsorption to a surface of the feeding tube, especially the inner surface, compared to an untreated feeding tube surface and/or to reduce or otherwise decrease clogging of the feeding tube compared to an untreated feeding tube. This effective amount of the source of the hydrophilic functional group, or the hydrophilic functional group, will vary depending on a variety of factors, including the nature of the feeding tube surface, the nature of the source of the hydrophilic functional group, the nature of the functional group(s) and the desired reduction in protein adsorption and/or clogging. The source of the hydrophilic functional group typically provides an amount of the hydrophilic functional group effective to reduce adsorption of proteins to a surface of the feeding tube, such as an inner surface, compared to an untreated surface and/or to reduce clogging of the feeding tube compared to an untreated feeding tube. In certain forms of the invention, the amount of the source of the hydrophilic functional group coated onto the desired surface is sufficient to provide a monolayer of a particular functional group on the surface. Typically, the amount of the source of the hydrophilic functional group coated onto the desired surface is sufficient to provide about 0.2×10⁻⁹ to about 1×10⁻⁹ moles of a particular functional group per mm² of surface. In many cases, at least about 0.1×10⁻⁹ moles of a particular functional group is applied per mm² of surface. In the case of an organic polymer, such as, for example, polyvinyl alcohol or polyethylene glycol, the amount of organic polymer provided to the surface of the feeding tube may range from about 0.2×10⁻¹⁵ to about 2×10⁻¹⁵ moles of polymer per mm² of surface, depending on the molecular weight. Generally, smaller amounts of the organic polymer will be needed when larger molecular weight polymers are utilized. These values can be adjusted higher or lower by one skilled in the art depending on the specific case.

These amounts of a source of hydrophilic functional group, and/or the amount of the hydrophilic functional group, is preferably sufficient to reduce adsorption of the proteins in feeding formula, including caseins, to the inner surface of a feeding tube by at least about 5%, preferably at least about 10%, further preferably at least about 25%, more preferably at least about 50%, and further preferably at least about 75% when compared to adsorption of the proteins to an untreated surface of a feeding tube. The amount of a source of hydrophilic functional group, and/or the amount of the hydrophilic functional group, is further preferably sufficient to reduce adsorption of the proteins in feeding formula to the inner surface of a feeding tube by at least about 90% and most preferably about 100%.

In other aspects of the invention, methods of reducing protein adsorption to a surface of a feeding tube and/or of reducing clogging of the feeding tube are provided. In one form, a method includes coating at least an inner surface of the feeding tube with an amount of a source of a hydrophilic functional group effective in reducing protein adsorption to the inner surface and/or in reducing clogging of the tube as described herein. In other forms of the invention, a method includes providing the inner surface of the feeding tube with a hydrophilic functional group in an amount effective in reducing protein adsorption to the inner surface and/or in reducing clogging of the feeding tube as described herein. In yet other forms of the invention, both the outer and inner surface of the feeding tube may be treated or otherwise modified as described herein.

Reference will now be made to specific examples illustrating the compositions and methods above. It is to be understood that the examples are provided to illustrate preferred embodiments and that no limitation to the scope of the invention is intended thereby.

### EXAMPLE 1

### Reduction of Protein Adsorption onto Hydrophobic Surfaces

Materials and Methods

Osmolite® was provided by Ross Products Division of Abbott Laboratories, Columbus, Ohio. Osmolite® is a feeding formula that contains about 35-40 g/L proteins. It includes various proteins of the casein family (84% by weight of the total proteins are caseins), as well as soy proteins (16% by weight) and other macromolecules, including lipids and vitamins. The composition of Osmolite® utilized included 37.1 g/L protein, 34.7 g/L fat, 151.1 g/L carbohydrate and 841 g/L Milli Q water.

A simulated gastric acid composition was prepared by combining 2.0 g sodium chloride, 3.2 g pepsin (Sigma Chemical Co., St. Louis, Mo.), 7 ml of hydrochloric acid and 993 ml water.

Preparation of Surfaces

A polyurethane film was formed by breaking up a sample of tubing from Ross Products Division of Abbott Laboratories into pieces and dissolving 0.1-0.2 g in 10 ml tetrahydrofuran (THF). A 0.1 ml aliquot of solution was pipetted onto a substrate which was spun into a 350-500 Å film using a spin coater. The film was dried under vacuum at 60° C. overnight. The film was modified with polyvinyl alcohol having a molecular weight of either 18,000 (PVA-1) or 155,000 (PVA-2) by forming solutions composed of 5 g polyvinyl alcohol in 100 ml water and ultrasonicating the solutions. Substrates with polyurethane films were placed into the polyvinyl alcohol solutions for 24 hours resulting in spontaneous adsorption of the polyvinyl alcohol to the polurethane films.

A self-assembled interface (SAM) was formed by making 0.1 M solutions of the thiol, 16-mercaptohexadecanol, in ethanol. Gold-coated substrates were placed into the thiol solutions for 2-3 days, were removed and cleaned by ultrasonication in ethanol. The SAMs formed by spontaneous assembly of the thiols onto the gold surface. It is noted that adsorption studies conducted in this Example represent 6-8 samples for each surface over the course of two experiments.

Experimental Protocol

The above-referenced surfaces were contacted alternately with an Osmolite® solution and a simulated gastric juice composition for 5 cycles, the duration of each cycle being 30 minutes for Osmolite® and 10 minutes for gastric juice.

The model surfaces (i.e., untreated polyurethane, PU; PVA-1-modified PU, PVA-2 modified PU; and hydroxylated SAM) were characterized by contact angle goniometer and ellipsometric thickness as seen in Table 1. For example, the amount of protein adsorbed was determined by ellipsometry and the contact angle was determined by contact angle goniometer. The thickness of the layer formed on the surface was also determined by ellipsometry.

TABLE 1
Characterization of chemically-modified surfaces.

| | Contact Angle | Thickness of Layer |
|---|---|---|
| Surface | (degrees) | (Angstrom) |
| Polyurethane (PU) | 83.2 ± 1.6 | 316.4 ± 161.1 |
| PVA-1-modified PU | 68.1 ± 1.9 | 21.8 ± 5.4 |
| PVA-2-modified PU | 60.44 ± 5.2 | 27.5 ± 82 |
| OH-SAM | 25 ± 2 | 20 ± 1 |

Results

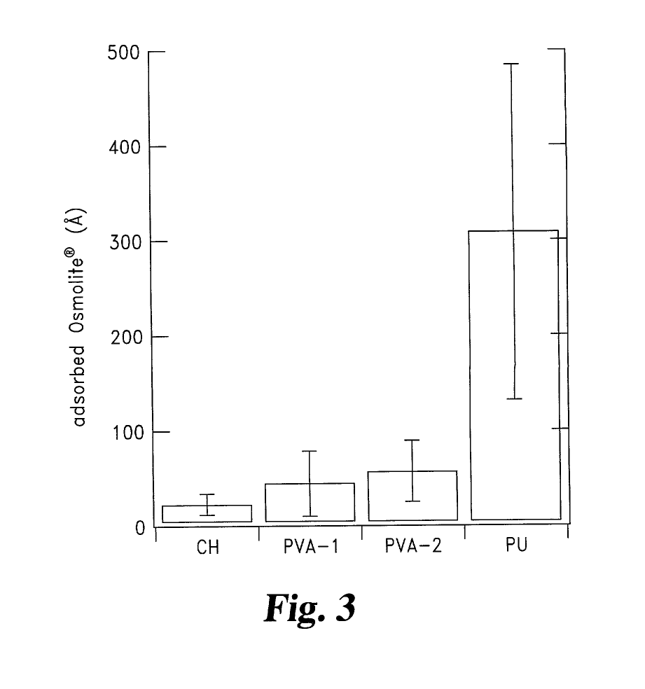

Feeding formula adsorption was highest in the untreated polyurethane group. Treating the PU surfaces with either PVA-1 or PVA-2 or by hydroxylating a SAM significantly decreased adsorption (about 6 to 10 fold) of Osmolite® onto the surfaces after five cycles of adsorption between Osmolite® and gastric juice as seen in FIG. 3. A significant decrease in Osmolite® adsorption onto the PVA-modified surfaces was observed, notwithstanding that the contact angle decreased only 15-23° from the hydrophobic polyurethane surface as seen in Table 1. This suggests that polymeric steric repulsive forces may be contributing to protein repulsion in addition to hydration forces due to the presence of hydroxyl groups in the PVA chain. These results indicate that surface modifications can significantly reduce feeding formula adsorption and may reduce clogging of the feeding tubes.

### EXAMPLE 2

### Effect of Coating Feeding Tubes with Polyvinyl Alcohol on the Flow of Protein Solutions Through the Tubes

Protein adsorption processes have been extensively studied (1-96). Protein will adsorb to a variety of surface chemistries depending on the protein, the surface chemistry and other conditions (20, 21). This laboratory has previously studied the adsorption of plasma and other proteins to ionic and hydrophobic surfaces in the presence of aqueous media (20-23, 29, 97-104). In those studies, it was found that, while many proteins will adsorb to surfaces, larger proteins adsorb and unfold most readily (20, 21). The present example examines the effect of coating feeding tubes with hydroxylated polymers on the flow of protein solutions through the tubes as measured by recording pressure fluctuations through the tubes.

### Materials and Methods

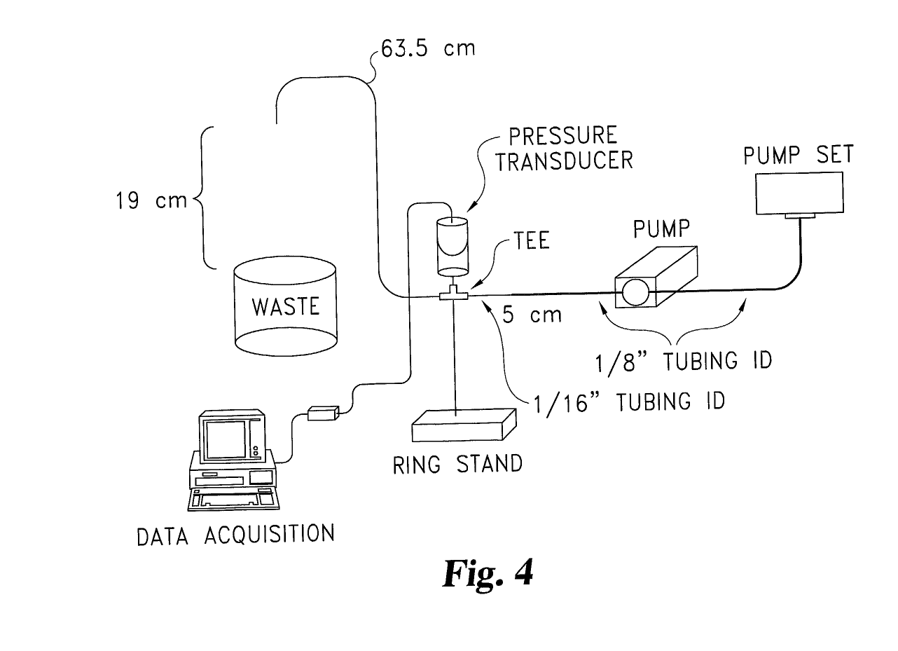

The setup used for these experiments is shown in FIG. 4. A Masterflex variable speed peristaltic pump (Cole Parmer, Vernon Hills, Ill.) and an Omegadyne PX4000CO-030G5T 30 psig pressure transducer (Omegadyne Inc., Sunbury, Ohio.) were used. The tubing consisted of multiple components. One component included the reservoir and feed line that was connected to a ⅛ inch inner diameter tubing segment to fit into the peristaltic pump. The 1/16 inch inner diameter polyurethane feeding tube (number 8 French) was divided into two segments in order to connect to the pump set to the pressure transducer. This was the portion of tubing that was being tested for clogging. Pipe adaptors and a tee were used to connect the pressure transducer to the feeding tube on both sides of the transducer. The length of the tested portion of the tube, from the outlet to the pressure transducer was 63.5 cm. The feeding tube, supplied by Ross Products Division of Abbott Laboratories (Columbus, Ohio.) was supplied with the stomach-end rounded and small holes located on either side. This portion of the tube was removed so as to eliminate effects of the geometry of the feeding tube outlet. Scientific Instruments data acquisition software Virtual Bench Logger was used to collect the data.

The “pump set” consisted of a reservoir, tubing, and connectors that connected to the feeding tube. The feeding tube was cut into two segments, one before (5 cm) and one after the pressure transducer. The segment of feeding tube downstream of the pressure transducer was 63.5 cm in length. This was the tubing that was tested for occlusion. For typical experiments, Osmolite® passed from the reservoir, through the tubing and pressure was measured with a data logger. The outlet was elevated 19 cm above the pressure transducer tee to keep all pressure positive. Periodically, gastric acid was introduced into the tube through the outlet by running the pump backwards. The gastric acid was stopped just before reaching the tee. Then, flow was resumed in the forward direction. Pressure often increased as feed solution coagulated as the gastric acid/Osmolite® mixture was being forced out the tube.

The feeding solution was Osmolite® (Ross Products Division, Columbus, Ohio.), isotonic liquid nutrition in a ready to use form as described in Example 1. Simulated gastric acid solution was prepared as described in Example 1. The polyvinyl alcohol (PVA) solution was prepared by dissolving 5 g 203S (PVA-2, MW 155,000 g/mole) polyvinyl alcohol in 100 ml Milli Q water.

For all experiments, the pump remained at a setting of 0.65, with the flow rate varying from 0.65 to 0.98 mL/min, with the exception of one cycling experiment with polyvinyl alcohol treated tubing. In that instance, the pump was set at 0.8 and the flow rate was 1.3 mL/min. The flow rate was recorded using a beaker, stopwatch, and balance. The density of Osmolite® was 1.087 g/mL. The baseline and maximum pressures possible from occlusion of the tube were tested. The baseline was substantially the same with a two-fold increase in the pump setting and the maximum pressures almost doubled. The first experiment was set up as shown in FIG. 4, but without a pressure transducer in line. This experiment involved flowing Osmolite®, with the exit portion of the tube placed in the inlet reservoir, so as to recycle all the feeding solution back into the system. All subsequent experiments involved using the pressure transducer as shown in FIG. 4. This allowed for the measurement of pressure under several different conditions.

Feeding tubes were coated with PVA by dissolving 5 g of 155,000 g/mole PVA in 100 ml water and placing the feeding tube in the PVA solution overnight. The PVA was allowed to adsorb for approximately 20 hours at room temperature. The PVA was then expelled and the system was rinsed with 1-10 ml of water. The feeding tube was used for several cycles, and when the experiment was completed, the tube was kept in the refrigerator until residual deposits on the inside tube were sampled for microbe analysis.

### Results

The recycling and cycling experiments discussed below were performed to document statistical sampling of clog-like events in order to mathematically define tube failure.

Recycling Experiment

Osmolite® was flowed continuously through the system. In these experiments, the pressure transducer was not incorporated into the system, so no pressure measurements were made. After about 36-48 hours, the Osmolite® solidified, completely blocking the flow. Under these conditions, the Osmolite® separated into a solid and liquid fraction. The liquid fraction was examined under an Olympic microscope under the 100× objective with oil and evidence of both bacteria and yeast were found (data not shown).

As controls, water and Osmolite® were eluted through the system without contacting the system with gastric acid solution and pressure measurements were made. When water was eluted through the system, the pressure fluctuated from approximately 0.34 to 0.35 psi. This pressure was due to a small elevation difference between the outlet and pressure transducer, the purpose of which was to provide a positive pressure. The elevation difference was kept constant at approximately 19 cm from the outlet to the bottom of the tee. When Osmolite® was passed through the system, there was no pressure change observed, even when the solution was allowed to elute for 16.5 hours. The small difference in pressure between Osmolite® (average pressure of 0.3952 psi) and water (average pressure of 0.3479) was due to the density of the Osmolite® compared to water.

Cycling Experiments

A set of Osmolite®/gastric acid cycles were run in a similar fashion as the cycling experiments above. To cycle Osmolite® and gastric acid through the system, the pump was switched manually.

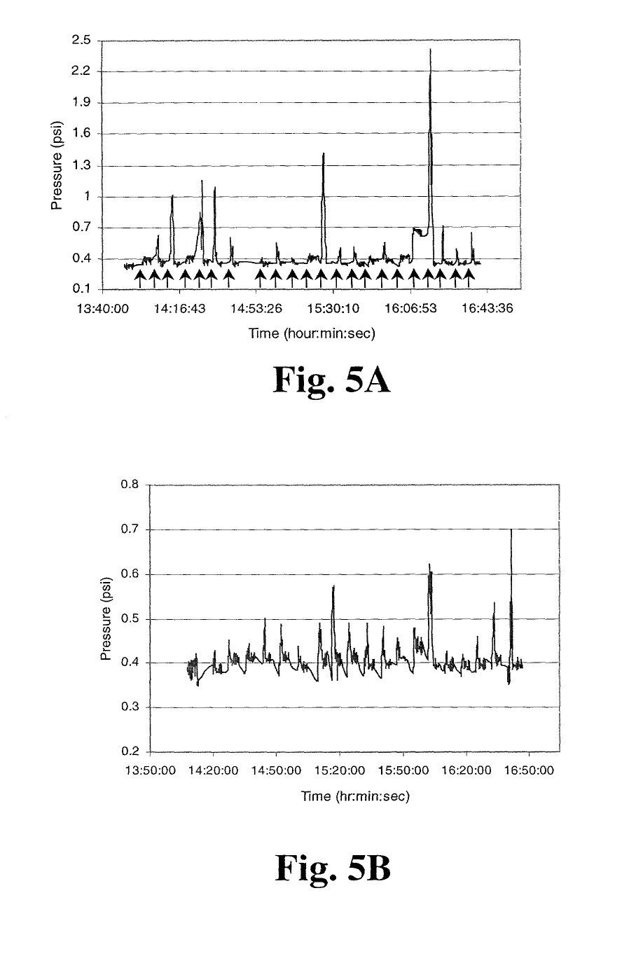

Osmolite® was eluted through the tube for 5 minutes at a flow rate of approximately 0.8 mL/min. During this time, data was being collected every 15 seconds. After the 5 minute interval, the pump was turned off, excess Osmolite® was shaken from the end of the feeding tube, and gastric acid was held at the outlet end of the feeding tube in a small beaker. Flow was reversed (at the same flow rate) until the gastric juice/Osmolite® interface came to within approximately 11.5 cm of the pressure transducer, traveling a distance of approximately 52 cm. The flow was again stopped, and the gastric acid beaker removed. Forward flow was resumed and data was collected for another 5 minutes, starting another cycle. For each experiment, approximately 20 cycles were completed. The pressure in the PVA coated tubes and control, uncoated tubes were recorded as a function of time and are shown in FIGS. 5A and 5B, respectively.

Referring to FIGS. 5A and 5B, it was found that the pressure spikes that occurred during some of the cycles were much smaller for PVA-treated feeding tubes of FIG. 5B compared to untreated tubes in FIG. 5A. These spikes appeared to represent the increased pressure from Osmolite® coagulating in the presence of acidic media. It is believed that this was due to the precipitation of caseins in the Osmolite®.

In order to more accurately define the differences between the treated and untreated conditions, the largest pressure spikes produced per every 10 cycles were averaged for three sets of tubing examined under identical conditions. These criteria were selected because the feeding tubes may fail when pressure reaches a maximum, averaged for three sets of tubing. The 10 consecutive cycles were selected by splitting each group of 20 cycles (run in a typical day) into two groups to best represent the highest pressures experienced in the system under each condition. In one case only 18 cycles were performed and these were divided into two groups of 9 cycles. In one case where only 7 cycles were performed, only one data point was extracted from this data. It is noted that a complete occlusion of the tubing that prevented all flow was not observed. It is further noted that microbes were present in the Osmolite® colored-deposits in the feeding tubes that remained after flushing the system with water after the end of each set of 20 cycles as determined with an Olympic microscope under the 100× objective with oil. These deposits were commonly observed after two or three days of using the feeding tubes. Moreover, the deposits were relatively small and few and did not appear to have any influence on the results, as the pressure spikes were no larger at the end of the experiments than they were at the beginning.

Effect of Feeding Tube Configuration

The feeding tubes investigated ended with an open, rounded tip, with 3 small holes on either side of the tube near the end. This design could give greater resistance to flow if coagulated feeding solution blocks one or more of the outlet holes. In the experiments described above, the tubes were cut just above the last hole to eliminate configuration as an important variable.

In order to determine whether the modified tubes had a significant influence on the results, two sets of cycles were performed with the rounded end intact. Three different types of tubing were examined in this study: unaltered, untreated tubing which did not have its end cut off, and altered tubing that had its end cut off and was either untreated or PVA-treated. The cycling experiments were performed as above. However, data points were also taken for passing Osmolite® alone in an untreated tube having its end cut off, which did not undergo the cycling with the simulated gastric acid. When Osmolite® was examined alone, data was collected every 15 min over 16.5 hr and was analyzed in the same manner, averaging the largest pressure spikes per every 7 data points, to result in a total number of data points similar to the quantities produced in each set of the cycling experiments.

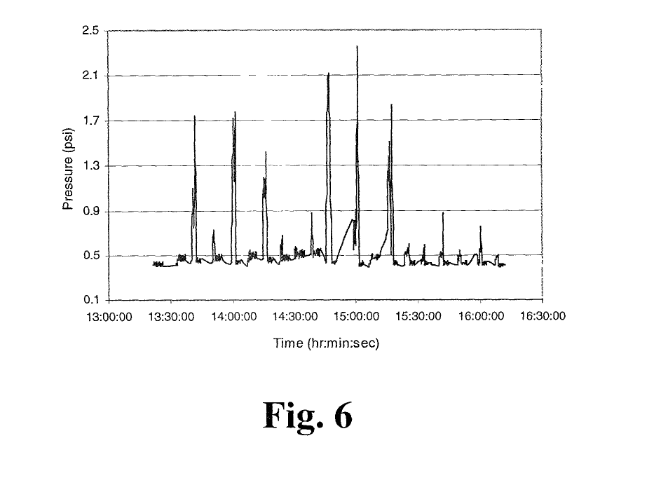

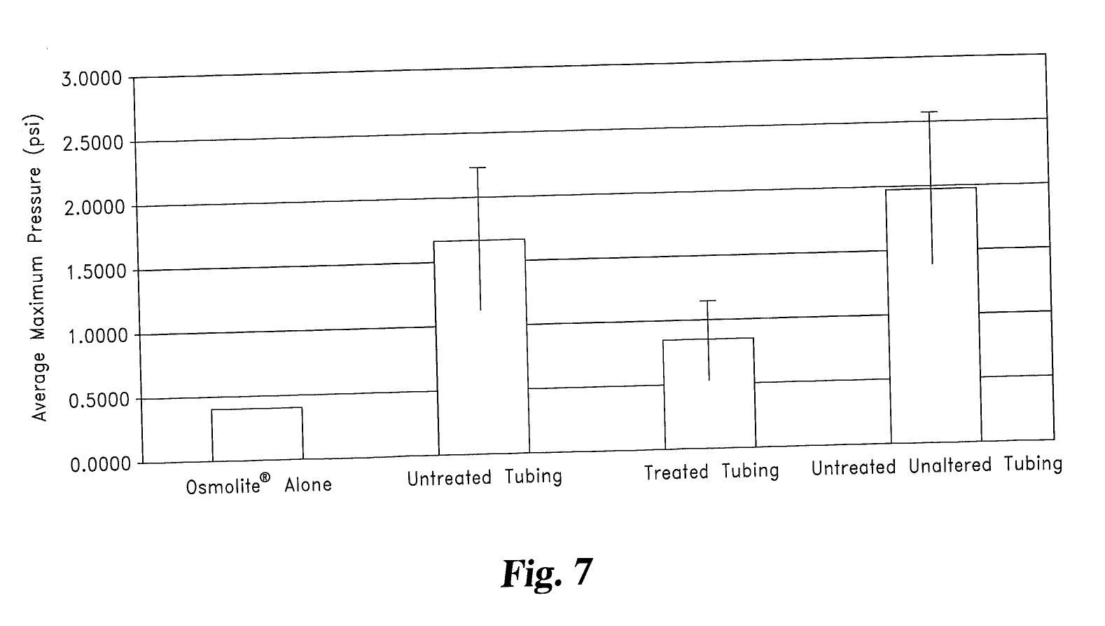

FIG. 6 depicts a pressure profile for 20 cycles of an untreated tube with a rounded tip, as provided by the manufacturer. FIG. 6 shows frequent and substantial pressure spikes during many of the acid-feed solution cycles. This suggests that the rounded tip geometry is less beneficial than the open end configuration. However, when the sampling events were averaged, there was only a slight but insignificant difference between this geometry and the cut-tip geometry (as seen in FIG. 7).

FIG. 7 depicts the averages and standard deviations of the peak pressures in the three tubes tested per 10 cycles. As seen in FIG. 7, the average of the pressure spikes was less in the treated tubes compared to the untreated tubes. This difference was significant (p<0.01), as was the difference between the treated and unaltered tubes (P<0.02). However, there was no statistically significant difference between the altered and unaltered tubes as mentioned above. All of the cycled tube pressures were significantly greater than the control, without gastric acid cycling.

Both treated and untreated tubes contained deposits after several days of use, which were shown to contain microorganisms. However, regardless of these deposits, the maximum pressures were, in general, less in the treated tubes and occurred less often, as demonstrated in FIG. 7. It is hypothesized that the PVA helped reduce the adhesion of precipitated proteins in the feeding tube. It may be that adding a polymeric alcohol such as PVA to the feeding solution would have a similar effect to that observed in this study.

### Conclusion

Protein adsorption is typically a fast process, while the unfolding of proteins can be slower. It has been observed that, either at body temperature or at room temperature, proteins will unfold within a few minutes, increasing their adhesion strength as the unfolding takes place [21, 100]. In some of the above experiments, the feeding solution was allowed to reside in the feed tube for 10 minutes or more and no differences were found in the pressures. Only when gastric acid was introduced into the system did the pressure increase significantly. In such cases, tubes treated with PVA displayed smaller pressure spikes than untreated tubes. Regardless of the mechanism involved, hydroxylated surfaces reduce protein adsorption in feeding tubes and may help reduce clogging of the feeding tubes.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. In addition, all references cited herein are indicative of the level of skill in the art and are hereby incorporated by reference in their entirety.

### References

1. Baszkin, A. and M. M. Boissonnade, Competitive adsorption of albumin and fibrinogen at solution-air and solution-polyethylene interfaces: in situ measurements, in Proteins at Interfaces II. 1995, American Chemical Society: Washington, D.C. p. 209-227.

2. Baty, A. M., et al., Adsorption of adhesive proteins from the marine mussel, Mytilus edulis, on polymer films in the hydrated state using angle dependent x-ray photoelectron spectroscopy and atomic force microscopy. Langmuir, 1997. 13: p. 5702-5710.

3. Buijs, J. and V. Hlady, Adsorption Kinetics, Conformation, and Mobility of the Growth Hormone and Lysozyme on Solid Surfaces, Studied with TIRF. J. Colloid and Interface Science, 1997. 190: p. 171-181.

4. Bujnowski, A. M. and W. G. Pitt, Water structure around enkephalin near a PE surface: A molecular dynamics study. Journal of Colloid and Interface Science, 1998. 203: p. 47-58.

5. Burns, N. L., K. Holmberg, and C. Brink, Influence of surface charge on protein adsorption at an amphoteric surface: Effects of varying acid to base ratio. Journal of Colloid and Interface Science, 1996. 178: p.116-122.

6. Caccavo, F., et al., Role of hydrophobicity in adhesion of the dissimilartory Fe(III)-reducing bacterium Shewanella alga to amorphous Fe(III) oxide. Applied and Environmental Microbiology, 1997. 63(10): p. 3837-3843.

7. Cavic, B. A. and M. Thompson, Protein adsorption to organsiloxane surfaces studied by acoustic wave sensor. The Analyst, 1998. 123: p. 2191-2196.

8. Chang, C. and A. M. Lenhoff, Comparison of protein adsorption isotherms and uptake rates in preparative cation-exchange materials. Journal of Chromatography A, 1998. 827: p. 281-293.

9. Chatelier, R. C. and A. P. Minton, Adsorption of globular proteins on locally planar surfaces: Models for the effect of excluded surface area and agfgregation of adsorbed protein on adsorption equilibria. Biophysical Journal, 1996. 71: p. 2367-2374.

10. Chinn, J. A., et al.,, Tenacious Binding of fibrinogen and albumin to pyrolite carbon and biomer. Journal of Colloid and Interface Science, 1996. 184:p. 11-19.

11. Choi, E. T. and A. D. Callow, The Effect of Biomaterials on the Host, in Implantation Biology, R. S. Greco, Editor. 1994, CRC Press: New York. p. 39-62.

12. DeFife, D. M., et al., Effects of photochemically immobilized polymer coatings on protein adsorption, cell adhesion, and the foreign body reaction to silicone rubber. Journal of Biomedical Materials Research, 1999. 44: p. 298-307.

13. Delville, A., et al.,, Correlations between the stability of charged interfaces and ionic exchange capacity: A Monte Carlo study. Langmuir, 1998. 14: p. 5077-5082.

14. Edmiston, P. L. and S. S. Saavedra, Molecular orientation distributions in protein films: III. Yeast cytochrome c immobilized on pyridyl disulfide-capped phospholipid bilayers. Biophysical Journal, 1998. 74: p. 999-1006.

15. Edwards, J. V., et al., Affinity of Cotton-bound peptides for the serine protease elastase. The FASEB Journal, 1999. 13(7): p. A1495.

16. Edwards, J. V., et al., Synthesis and activity of NH2— and COOH— terminal elastase recognition sequences on cotton. Journal of Peptide Research, 1999. 54: p. 536-543.

17. Fernandez, M. A., W. S. Laughinghouse, and G. Carta, Characterization of protein adsorption by composite silica-polyacrylamide gel anio exhangers II. Mass transfer in packed columns and predictability of breakthrough behavior. J. of Chromatography A, 1996. 746: p. 185-198.

18. Finette, G. M. S., et al., Adsorption Behavior of Multicomponent Protein Mixtures Containing alpha-1-proteinase inhibitor with the anion exchanger, 2-(diethylamino)ethyl-spherodex. Biotechnology, 1997. 13: p. 265-275.

19. Gardella, J. A., et al. Quantitative surface analysis of polymeric biomaterials: state of the art in XPS, SIMS, and MALDI-ToF-MS. in 1999 Surfaces in Biomaterials Symposium. 1999. Scottsdale, Arizone: Surfaces in Biomaterials Foundation.

20. Goheen, S. C., et al., Surface-mediated unfolding of cytochrome c. FASEB Journal, 1999. 13(7): p. A1495.

21. Goheen, S. C. and B. M. Gibbins, Protein losses in ion exchange and hydrophobic interaction HPLC. Journal of Chromatography A, 2000. 890:73-80.

22. Green, R. J., et al., Surface Plasmon Resonance for Real Time in situ Analysis of Protein Adsorption to Polymer Surfaces. Biomaterials, 1997. 18: p. 405-413.

23. Green, R. J., et al.,, Competitive protein adsorption as observed by surface plasmon resonace. Biomaterials, 1999: p. 385-391.

24. Grunkemeier; J. M. and T. A. Horbett, Fibrinogen adsorption to receptor-like biomaterials made by pre-adsorbing peptides to polystyrene substrates. Journal of Molecular Recognition, 1996. 9: p. 247-257.

25. Grunkemeier, J., C. Wan, and T. Horbett, Changes in binding affinity of a monoclonal antibody to a platelet binding domain of fibrinogen adsorbed to biomaterials. Journal of Biomaterials Science, Polymer Edition, 1996. 8(3): p. 189-209.

26. Grunze, M., P. Harder, and R. Dahint. Adhesion of proteins on self-assembled organic model surfaces, in The 20th Annual Meeting of the Adhesion Society. 1997. Hilhar Head Island, S.C.

27. Han, D. K., et al., Plasma Protein Adsorption to Sulfonated Poly(Ethylene Oxide)-Grafted Polyurethane Surface. Journal of Biomedical Materials Research, 1996. 30: p. 23-30.

28. Hansen, E. and J. Mollerup, Application of the two-film theory to the determination of mass transfer coefficients for boving serum albumin on anion-exchange columns. Journal of Chromatography A, 1998. 827: p. 259-267.

29. Herbold, C. W., J. H. Miller, and S. C. Goheen, Cytochrome c unfolding on an anionic surface. Journal of Chromatography A, 1999. 863: p. 137-146.

30. Heyse, S., et al.,, Emerging techniques for investigating molecular interactions at lipid membranes. Biochimica et Biophysica Acta, 1998. 85507: p. 319-338.

31. Ishihara, K., et al., Improved Blood Compatibility of Segmented Polyurethane by Polymeric Additives Having Phospholipid Polar Group II Dispersion State of the Polymeric Additive and Protein Adsorption on the Surface. Journal of Biomedical Materials Research, 1996. 32: p. 401-408.

32. lvanov, A. E., et al., Effect of temperature upon the chromatography of proteins on porous glass, chemically coated with N-isopropylacrylamide copolymer. Journal of Chromatography A, 1997. 776: p. 75-80.

33. Johnson, R. D., Z.-G. Wang, and R. H. Arnold, Surface site heterogeneity and lateral interactions in multipoint protein adsorption. J. Physical Chemistry, 1996. 100: p. 5134-5139.

34. Joscelyne, S. and C. Tragardh, Kinetics of colloidal deposition and release of polystyrene latex particles in the presence of adsorbed beta-lactoglobulin studied using a flow cell. Journal of Colloid and Interface Science, 1997. 192: p. 294-305.

35. Kim, J. C. and D. B. Lund, Kinetics of beta-lactoglobulin adsorption onto stainless steel surfaces. Biotechnology Progress, 1998. 14: p. 951-958.

36. Kingshott, P., H. A. W. S. John, and H. J. Griesser, Direct Detection of Proteins Adsorped on Synthetic Materials by Matrix-Assisted Laser Desorption Ionization-Mass Spectrometry. Analytical Biochemistry, 1999. 273: p. 156-162.

37. Kokubo, K.-I., M. Taguchi, and K. Sakai, Changes in charge and ion permeability of PAN-DX dialysis membrane caused by protein adsorption. The Chemical Engineering Journal, 1996. 62: p. 73-79.

38. Kriwacki, R. W., et al., Probing protein/protein interactions with mass spectrometry and isotopic labeling: analysis of the p21/Cdk2 complex. Journal of the American Chemical Society, 1996. 118: p. 5320-5321.

39. Kubota, N., et al., Comparison of Two Convection-Aided Protein Adsorption Methods Using Porous Membranes and Perfusion Beads. Biotechnol. Prog., 1996. 12(6): p. 869-872.

40. Kundu, A., K. A. Barnthouse, and S. M. Cramer, Selective Displacement Chromatography of Proteins. Biotechnology and Bioengineering, 1997. 56: p. 119-129.

41. Lamkin, M. S., A. A. Arancillo, and F. G. Oppenheim, Temporal and Compositional Characteristics of Salivary Protein Adsorption to Hydroxyapatite. Journal of Dental Research, 1996. 75(2): p. 803-808.

42. Lassen, B. and M. Malmsten, Competitive protein adsorption at plasma polymer surface. J. of Colloid and Interface Science, 1997. 186: p. 9-16.

43. Lee, J. H., B. J. Jeong, and H. B. Lee, Plasma Protein Adsorption and Platelet Adhesion onto Comb-Like PEO Gradient Surfaces. Journal of Biomedical Materials Research, 1996. 34: p. 105-114.

44. Lin, J.-C. and S. L. Cooper, In vitro fibrinogen adsorption from various dilutions of human blood plasma on grow discharge modified polythylene. Journal of Colloid and Interface Science, 1996: p. 315-325.

45. Ljunglof, A. and R. Hjorth, Confocal microscopy as a tool for studying protein adsorption to chromatographic matrices. J. of Chromatography A, 1996. 743: p. 75-83.

46. Lu, J. R., et al, The denaturation of lysozyme layers adsorbed at the hydrophobic solid/liquid surface studied by neutron reflection. Journal of Colloid and Interface Science, 1998: p. 212-223.

47. Luck, M., et al., Analysis of plasma protein adsorption on polymeric nanoparticles with different surface characteristics. J. Biomed. Mater. Res, 1998, 39:478-485.

48. Malmsten, M. and A. Veide, Effects of amino acid composition on protein adsorption. Journal of Colloid and Interface Science, 1996. 178: p. 160-167.

49. Mandrusov, E., et al., Kinetics of Protein Deposition and Replacement from a Shear Flow. Amer. Inst. Chem. Eng. J., 1998(February, 1998).

50. Maste, M. C. L., W. Norde, and A. J. W. G. Visser, Adsorption-induced conformational changes in the serine proteinase savinase: A tryptophan fluorescence and circular dichroism study. Journal of Colloid and Interface Science, 1997. 196: p. 224-230.

51. McPherson, T., et al.,, Prevention of protein adsorption by tethered poly(ethylene oxide) layers: Experiments and single-chain mean-field analysis. Langmuir, 1998. 14: p. 176-186.

52. Medved, L., et al, Domain structure and functional activity of the recombinant human fibrinogen gamma-module (gamma 148-411). Biochemistry, 1997. 36(15): p. 4685-4693.

53. Mei, H.C.v.d., S. Meijer, and H. J. Busscher, Electrophoretic mobilities of protein-coated hexadecane droplets at difference pH. Journal of Colloid and Interface Science, 1998: p. 185-190.

54. Membrez, J., P. P. Infelta, and A. Renken, Use of the laplace transform technique for simple kinetic parameters evaluation. Application to the adsorption of a protein on porous beads. Chemical Engineering Science, 1996. 51(19): p. 4489-4498.

55. Mingalyov, P. G. and A. Y. Fadeev, Comment on the theory of protein adsorption on a biospedific rigid matrix. J. of Chromatography, 1997. 764: p. 21-26.

56. Minton, A. P., Adsorption of globular proteins on locally planar surfaces. II. Models for the effect of multiple adsorbate conformations on adsorption equilibria and kinetics. Biophysical Journal, 1999. 76: p. 176-187.

57. Muskowitz, K. A., B. Kudryk, and B. S. Coller, Fibrinogen coating density affects the conformation of immobilized fibrinogen: implications for platelet adhesion and spreading. Thromb Haemost, 1998. 79(4): p. 824-831.

58. Nash, D. and H. Chase, Modification of polystyrenic matrices for the purification of proteins III. effects of poly(vinyl alcohol) modification on the characterisics of protein adsorption on conventional and perfusion polystyrenic matrices. Journal of Chromatography A., 1997. 776: p. 65-73.

59. Noinville, V., C. Vidal-Madjar, and B. Sebille, Modeling of protein adsorption on polymer surfaces. Computation of adsorption potential. Journal of Physical Chemistry, 1995. 99: p. 1516-1522.

60. Ortega-Vinuesa, J. L., P. Tengvall, and I. Lundstrom, Aggreagation of hsa, igG and fibrinogen on methlyated silicon surfaces. Journal of Colloid and Interface Science, 1998: p. 228-239.

61. Ortega-Vinuesa, J. L., et al., Stagnant versus dynamic conditions: a comparative adsorption study of blood proteins. Biomaterials, 1998: p. 251-262.

62. Pfeiffer, N., et al.,, Effects of secondary flow caused by a curved channel on plasma protein adsorption to artificial surfaces. Biotechnology Progress, 1998. 14: p. 338-342.

63. Pitt, W. G. and D. R. Weaver, Calculation of protein-polymer force fields using molecular dynamics. Journal of Colloid and Interface Science, 1997. 185: p. 258-264.

64. Ratnayake, C. K. and F. E. Regnier, Lateral interaction between electrostatically adsorbed and covalently immobilized proteins on the surface of cation-exchange sorbents. J. Chromatogr. A, 1996. 743: p. 25-32.

65. Roth, C. M., K. K. Unger, and A. M. Lenhoff, Mechanistic model of retention in protein ion-exchange chromatography. Journal of Chromatography A, 1996. 726: p. 45-56.

66. Roth, C. M., B. L. Neal, and A. M. Lenhoff, Van der Waals interactions involving proteins. Biophysical Journal, 1996. 70: p. 977-987.

67. Ruiz-Bevia, F., et al., An improved model with time-dependent adsorption for simulating protein ultrafiltration. Chemical Engineering Science, 1997. 52(14): p. 2343-2352.

68. Satulovsky, J., M. A. Carignano, and I. Szleifer, Kinetic and thermodynamic control of protein adsorption. PNAS, 2000. 97(16): p. 9037-9041.

69. Seigel, R. R., et al., On-Line Detection of Nonspecific Protein Adsorption at Artificial Surfaces. Analytical Chemistry, 1997. 69(16): p. 3321-3328.

70. Skarja, G. A., et al.,, Protein and platelet interactions with thermally denatured fibrinogen and cross-linked fibrin coated surfaces. Biomaterials, 1998: p. 2129-2138.

71. Soderling, E., et al., Protein Adsorption to a Bioactive Glass With Special Reference to Precorrosion. Journal of Biomedical Materials Research, 1996. 31: p. 525-531.

72. Takami, Y., et al.,, Protein adsorption onto ceramic surfaces. J. Biomed. Mater. Res. 1998, 40:24-30.

73. Tang, L., Mechanisms of fibrinogen domains: biomaterial interactions. Journal of Biomaterials Science: Polymer Edition, 1998. 9(12): p. 1257-1266.

74. Tassel, P. R. V., et al.,, Kinetics of irreversible adsorption with a particle conformational change: A density expansion approach. Physical Review E, 1996. 53(1): p. 785-798.

75. Tassel, P. R. V., et al., Control of Protein Adsorption in Capillary Electrophoresis via an Irreversibly Bound Protein Coating. J. of Colloid and Interface Science, 1996. 183: p. 269-273.

76. Tassel, P. R. V., P. Viot, and G. Tarjus, A kinetic model of partially reversible protein adsorption. J. Chem. Phys., 1997. 106(2): p. 761-770.

77. Tassel, P. R. V., et al., A particle-level model of irreversible protein adsorption with a postadsorption transition. Journal of Colloid and Interface Science, 1998: p. 317-323.

78. Tengvall, P., A. Askendal, and I. Lundstrom, Studies on protein adsorption and activations of complement on hydrated aluminium surfaces in vitro. Biomaterials, 1998: p. 935-940.

79. Thode, K., et al., The influence of the sample preparation on plasma protein adsorption patterns on polysaccaride-stabilized iron oxide particles and n-terminal microsequencing of unknown proteins. Journal of Drug Targeting, 1998: p. 459-469.

80. Thommes, J., Investigations on protein adsorption to agarose-dextran composite media. Biotechnology and Bioengineering, 1999. 62(3): p. 358-362.

81. Tidwell, C. D., et al., Endothelial Cell Growth and Protein Adsorption on Terminally Functionalized, Self-Assembled Monolayers of Alkanethiolates on Gold. Langmuir, 1997. 13: p. 3404-3413.

82. Tsai, W.-B., J. M. Grunkemeier, and T. A. Horbett, Human plasma fibrinogen adsorption and platelet adhesion to polystyrene. Journal of Biomedical Materials Research, 1999. 44: p. 130-139.

83. Tzannis, S. T., et al., Adsorption of a formulated protein on a drug delivery device surface. J. of Colloid and Interface Science, 1997. 189: p. 216-228.

84. Vegt, W. V. d., et al., pH dependence of the kinetics of interfacial tension changes during protein adsorption from sessile droplets on FEP-Teflon. Colloid Polymer Science, 1996. 274: p. 27-33.

85. Wang, L., R. X. Chen, and N. R. Kallenback, Proteolysis as a probe of thermal unfolding of cytochrome c. Proteins: Structure, Function, and Genetics, 1998. 30: p. 435-441.

86. Weaver, L. E. and G. Carta, Protein adsorption on cation exchangers: comparison of macroporous and gel-composite media. Biotechnology Progress, 1996. 12: p. 342-355.

87. Welle, A., M. Grunze, and D. Tur, Plasma protein adsorption and platelet adhesion on poly[bis(trifluoroethoxy) phosphazene] and refernece material surfaces. Journal of Colloid and Interface Science, 1998: p. 263-274.

88. Whitlock, P. W., S. J. Clarson, and G. S. Retzinger, Fibrinogen adsorbs from aqueous media to microscopic droplets of poly(dimethylsiloxane) and remains coagulable. Journal of Biomedical Materials Research, 1999. 45: p. 55-61.

89. Xu, X.-H. N. and E. S. Yeung, Long-range electrostatic trapping of single-protein molecules at a liquid-solid interface. Science, 1998. 281: p. 1650-1653.

90. You, H. X. and C. R. Lowe, AFM Studies of protein adsorption: 2. Characterization of immunoglobulin G adsorption by detergent washing. Journal of Colloid and Interface Science, 1996. 182: p. 586-601.

91. Yu, J.-L., R. Andersson, and A. Ljungh, Protein adsorption and bacterial adhesion to binary stent materials. Journal of Surgical Research, 1996. 62: p. 69-73.

92. Yu, J.-L., S. Johansson, and A. Ljungh, Fibronectin exposes different domains after adsorption to a heparinized and an unheparinized poly(vinyl chloride) surface. Biomaterials, 1997. 18: p. 421-427.

93. Zachariou, M. and M. T. W. Hearn, Application of immobilized metal ion chelate complexes as pseudocation exchange adsorbents for protein separation. Biochemistry, 1996. 35: p. 202-211.

94. Zembala, M., J. C. Voegel, and P. Schaaf, Elution process of adsorbed fibrinogen by SDS: competition between removal and anchoring. Langmuir, 1998. 14: p. 2167-2173.

95. Zhang, M., T. Desail, and M. Ferrari, Proteins and cells on PEG immobilized silicon surfaces. Biomaterials, 1998: p. 953-960.

96. Zoungrana, T., G. H. Findenegg, and W. Norde, Structure, stability, and activity of adsorbed enzymes. Journal of Colloid and Interface Science, 1997. 190: p. 437-448.

97. Goheen, S. C., High Performance Hydrophobic Interaction Chromatography of Proteins, in Methods for Protein Analysis, J. Cherry and R. A. Barford, Editors. 1988, American Oil Chemist Society: Champaign, Ill. p. 156-170.

98. Goheen, S. C. and J. L. Hilsenbeck, The adsorption of plasma proteins on polar surfaces, Presented at the 1997 Surfaces in Biomaterials Symposium, Minneapolis, Minn., Sep. 3-6, 1997.

99. Goheen, S. C. and J. L. Hilsenbeck, High-performance ion-exchange chromatography and adsorption of plasma proteins, Presented at the 1997 International Symposium on Proteins, Peptides, and Polynucleotides, Rockville, Md., Oct. 26-29, 1997.

100. Goheen, S. C. and J. L. Hilsenbeck, High-performance ion-exchange chromatography and adsorption of plasma proteins. J. Chromatography A, 1998. 816(1): p. 89-96.

101. Goheen, S. C. and J. L. Hilsenbeck, Quantitation of protein adsorption and surface-mediated unfolding processes using a continuous flow-through system, Presented at Surfaces in Biomaterials Conference, Tucson, Ariz., Sep. 2-5, 1998.

102. Goheen, S. C., et al. Adsorption and surface-mediated unfolding of proteins, in National ACS Meeting. 1999. New Orleans, La.

103. Goheen, S. C., et al. Protein Adsorption and Temperature Effects. in Surfaces in Biomaterials Conference. 1999. Phoenix, Ariz.

104. Hilsenbeck, J., B. Gibbins, and S. Goheen, The Behavior and Chromatography of Fibrinogen. The FASEB Journal, 1999. 13(7): p. A1555.

What is claimed is:

1. A feeding tube, comprising an elongated member having an inner surface and an outer surface, said inner surface defining a lumen, at least said inner surface coated with an amount of a source of a hydrophilic functional group effective to reduce adsorption of proteins to said inner surface.

2. The tube of claim 1, wherein said tube is comprised of a hydrophobic material.

3. The tube of claim 1 , wherein said hydrophilic functional group is selected from the group consisting of hydroxyl, carboxyl, amino, sulfate, sulfonate, and combinations thereof.

4. The tube of claim 1, wherein said source of a hydrophilic functional group is an organic polymer.

5. The tube of claim 4, wherein said organic polymer is selected from the group consisting of polyvinyl alcohol, polyethylene glycol polyethylene oxide, a polysaccharide and combinations thereof.

6. The tube of claim 4, wherein said inner surface of said feeding tube includes about 0.2×10⁻⁹ to about 1×10⁻⁹ moles of said functional groups per mm² of said inner surface.

7. The tube of claim 3, wherein said hydrophilic functional group is hydroxyl.

8. A feeding tube, comprising an elongated member having an inner surface and an outer surface, at least said inner surface coated with an amount of a source of a hydrophilic functional group effective in reducing adsorption of proteins to said inner surface, said functional group selected from the group consisting of hydroxyl, carboxyl, amino, sulfate, sulfonate, phosphate, phosphonate, nitrile, ether, amide, aldehyde, ester and combinations thereof.

9. The feeding tube of claim 8, wherein said source of a hydrophilic functional group is an organic polymer.

10. The feeding tube of claim 8, wherein said organic polymer is selected from the group consisting of polyvinyl alcohol, polyethylene glycol polyethylene oxide, a polysaccharide and combinations thereof.

11. The feeding tube of claim 8, wherein said tube is comprised of polyurethane.

12. A feeding tube, comprising an elongated member having an inner surface and an outer surface, said inner surface defining a lumen, at least said inner surface having a hydrophilic functional group in an amount effective in reducing protein adsorption to said inner surface.

13. A feeding tube, comprising an elongated member having an inner surface and an outer surface, said inner surface defining a lumen, at least said inner surface provided with an organic polymer having a hydrophilic functional group in an amount effective to reduce protein adsorption to said inner surface by at least about 5%.

14. A method of reducing protein adsorption to a surface of a feeding tube, said feeding tube having an inner surface and an outer surface, comprising coating at least said inner surface of said feeding tube with an amount of a source of a hydrophilic functional group effective in reducing protein adsorption to said inner surface.

15. The method of claim 14, wherein said source of a hydrophilic functional group is an organic polymer.

16. The method of claim 15, wherein said organic polymer is selected from the group consisting of polyvinyl alcohol, polyethylene glycol polyethylene oxide, a polysaccharide and combinations thereof.

17. The method of claim 15, wherein said hydrophilic functional group is selected from the group consisting of hydroxyl, carboxyl, amino, sulfate, sulfonate and combinations thereof.

18. The method of claim 17, wherein said hydrophilic functional group is hydroxyl.

19. A method of reducing protein adsorption to a surface of a feeding tube having an inner surface and an outer surface, said inner surface defining a lumen, comprising providing said inner surface of said feeding tube with a hydrophilic functional group in an amount effective in reducing protein adsorption to said inner surface.

20. The method of claim 19, wherein said hydrophilic functional group is selected from the group consisting of hydroxyl, carboxyl, amino, sulfate, sulfonate and combinations thereof.

21. The method of claim 20, wherein said hydrophilic functional group is hydroxyl.
